(19) United States
(12) Patent Application Publication
(10) Pub. No.: US 2015/0269141 A1
(43) Pub. Date: Sep. 24, 2015

(54) SYSTEM AND METHOD FOR DETERMINING INDIAN LANGUAGE COMPATIBILITY OF A USER INTERFACE PROGRAM

(71) Applicant: REVERIE LANGUAGE TECHNOLOGIES PRIVATE LIMITED, BANGALORE (IN)

(72) Inventors: PRANJAL NAYAK, BANGALORE (IN); CHANDAN BHAGABATI, BANGALORE (IN)

(21) Appl. No.: 14/659,506

(22) Filed: Mar. 16, 2015

(30) Foreign Application Priority Data
Mar. 20, 2014 (IN) 1476/CHE/2014

(51) Int. Cl. G06F 17/28; G06F 17/27

(52) U.S. Cl. CPC G06F 17/28; G06F 17/2705

(57) ABSTRACT

A system for determining the Indian language compatibility of a user interface program selects a string and splits the string into its constituent characters. The width of each of the constituent characters of the string is determined, and summed up. Similarly, the width of the entire string is also determined. The system compares the width of the entire string with the resultant of summation of the width of each of the constituent characters. In the event that the result of summation is at least one and a half times greater than the width of the entire string, the system determines the user interface program to be compatible with Indian language scripts.

### CROSS REFERENCE TO RELATED APPLICATIONS

This patent application claims the priority of the Indian Provisional Patent Application No. 1476/CHE/2014 filed on Mar. 20, 2014, having the title “Auto Detection of Display Support for Text for Any Script”, and the content of which is incorporated herein by reference in its entirely.

### DEFINITION OF TERMS USED IN THIS SPECIFICATION

The term ‘Devanagari’ used in this specification refers to a writing nomenclature adhered to by a plurality of Indian languages including but not restricted to Hindi, Marathi, Konkani, Bodo, and Maithilli.

The term ‘conjunct consonant’ used in this specification refers to a word that includes a combination of consonants and a half-consonant, in the context of an Indian language.

The term ‘half-consonant’ used in this specification refers to an alphabet which only includes half the portion of its consonant equivalent. In the context of Indian languages, a half-consonant combines with another consonant and forms a conjunct.

### BACKGROUND

1. Technical Field

The embodiments herein relates to computer implemented tools that check the compatibility of user interface programs in respect of a language script. Particularly, the embodiments herein relates to systems and methods that determine whether a user interface program is compatible with Indian Language scripts. More particularly, the embodiments herein relates to systems and methods that determine whether a user interface program can facilitate display of Indian language scripts including but not restricted to Devanagari script.

2. Description of Related Art

A foreign language such as English is characterized as encompassing a linear script, since the letters of an ‘English’ word include neither vowel-signs nor conjunct consonant characters. Typically, any language based on Latin script is characterized as a linear script, given its written representation. However, in case of Asian scripts including (but not restricted to) ‘Devanagari’, letters of a word can be represented as a combination of vowels, consonants, vowel signs and conjunct consonant characters. Moreover, Devanagari representations may not follow a linear format all the time contrary to any Latin based script.

A typical user interface program which has been optimized to implement/display non-linear scripts/fonts may not be suitable for displaying script/fonts which are representing non-linear scripts such as the Devanagari. Since scripts such as the Devanagari, require rendering engines that function in a manner different than that of conventional rendering engines used to render linear scripts, a user interface program which uses a conventional rendering engine may not display non-linear scripts such as Devanagari in an appropriate manner.

Given that the (online/off-line) representation of non-linear scripts is completely different from representation of linear scripts, non-linear scripts are required to be processed by (a) user interface program in a manner different from processing of linear scripts. Further, the parameters analyzed by the user interface program including but not restricted to character recording, contextual shaping, recognition and display of vowel-signs, recognition and display of conjunct consonant characters, insertion of word breaks, processing sentence alignments, vary significantly, when a user interface program is required to display words/sentences based on non-linear scripts such as the Devanagari.

However, a user interface program which has been specifically designed and optimized to display linear scripts may not appropriately monitor and analyze the differences in the aforementioned parameters, during the display of a non-linear script, thereby resulting in the non-linear script being displayed in an inappropriate manner and in a manner which is not aesthetic, and not easily comprehendible by a user.

Therefore, in order to obviate the aforementioned drawbacks, the embodiments herein envisages a computer implemented system and method that determines whether a user interface program is compatible with Indian Language scripts including but not restricted to Devanagari.

The above mentioned shortcomings, disadvantages and problems are addressed herein and which will be understood by reading and studying the following specification.

### OBJECTIVES OF THE EMBODIMENTS

The primary object of the embodiments herein is to provide a computer implemented system for inspecting the compatibility of a user interface program.

Another object of the embodiments herein is to provide a computer implemented system for determining whether a user interface program supports rendering and display of Indian Language scripts.

Yet another object of the embodiments herein is to provide a computer implemented system that determines the characteristics of a script in order to ascertain whether a user interface program supports the said script.

Yet another object of the embodiments herein is to provide a computer implemented system that assists in efficient rendering of Indian language scripts.

Yet another object of the embodiments herein is to provide a computer implemented system that enables a user to seamlessly determine whether a user interface (program) supports rendering and display of Indian Language scripts.

Yet another object of the embodiments herein is to provide an easy-to-use computer implemented system which enables the user to determine the compatibility of a user interface with respect to Indian language scripts, without taking into consideration the programming specifics of the user interface.

These and other objects and advantages of the embodiments herein will become readily apparent from the following detailed description taken in conjunction with the accompanying drawings.

### SUMMARY

The embodiments herein envisages a computer implemented system for determining the compatibility of a user interface program with an Indian language script. The system comprises a selector module configured to select at least one string incorporating an Indian language script, the string designated to be displayed on a user interface controlled by the user interface program.

The system envisaged by the embodiments herein further comprises an analyzer module configured to parse the string and split the string into constituent characters thereof.

The system envisaged by the embodiments herein further includes a processor configured to:
determine the width of the string;
analyze each of the constituent characters of the string and calculate the width of an analyzed constituent character in the event that the constituent character is determined to be a vowel;
analyze each of the constituent characters of the string and calculate the width of an analyzed constituent character in the event that the constituent character is determined to be a consonant;
analyze each of the constituent characters of the string and determine whether an analyzed constituent character includes a combination of a consonant and a vowel-sign;
split the analyzed constituent character into the consonant and a vowel equivalent to the vowel-sign, only in the event that the analyzed constituent character is a combination of a consonant and a vowel-sign, and calculate the respective widths of the consonant and the vowel, and further calculate the width of the analyzed constituent character, wherein the width of the analyzed constituent character is a summation of the respective widths of the consonant and the vowel;
analyze each of the constituent characters of the string and determine whether an analyzed constituent character is a conjunct consonant;
split the analyzed constituent character into at least two consonants, wherein said two consonants in combination would form the analyzed constituent character, and calculate the respective widths of the two consonants, and further calculate the width of the analyzed constituent character, wherein the width of the analyzed constituent character is a summation of the respective widths of the two consonants;
add the widths of each of the analyzed constituent characters and generate a cumulative width, said cumulative width being a resultant of addition of widths of each of the analyzed constituent characters;
compare the cumulative width with the width of the string, and determine whether the cumulative width is greater than the width of the string; and
determine the user interface program to be compatible with the Indian language script, only in the event that the cumulative width is greater than the width of the string.

The system further includes a determinator module configured to declare the user interface program as being compatible with the Indian language script, only in the event that the cumulative width of the constituent characters is at least one and a half times greater than the width of the string, wherein the width is a function of character size.

In accordance with the embodiments herein, the analyzer is further configured to parse each of the constituent characters of the string and determine whether each of the constituent characters is one of a vowel, a consonant and a vowel-sign.

In accordance with the embodiments herein, the processor is further configured to declare the user interface program as being non-compatible with the Indian language script, only in the event that the cumulative width of the constituent characters is lesser than one and a half times the width of the entire string.

A computer implemented method for determining the compatibility of a user interface program with an Indian language script, the method comprising the following computer implemented steps:
selecting at least one string incorporating an Indian language script,
wherein the string is designated to be displayed on a user interface controlled by the user interface program;
parsing the string and splitting the string into constituent characters thereof;
determining the width of the string;
analyzing each of the constituent characters of the string and calculating the width of an analyzed constituent character in the event that the constituent character is determined to be a vowel;
analyzing each of the constituent characters of the string and calculating the width of an analyzed constituent character in the event that the constituent character is determined to be a consonant;
analyzing each of the constituent characters of the string and determining whether an analyzed constituent character includes a combination of a consonant and a vowel-sign;
splitting the analyzed constituent character into the consonant and a vowel equivalent to the vowel-sign, only in the event that the analyzed constituent character is a combination of a consonant and a vowel-sign, and calculating the respective widths of the consonant and the vowel, and further calculating the width of the analyzed constituent character, wherein the width of the analyzed constituent character is a summation of the respective widths of the consonant and the vowel;
analyzing each of the constituent characters of the string and determining whether an analyzed constituent character is a conjunct consonant;
splitting the analyzed constituent character into at least two consonants, wherein said two consonants in combination would form the analyzed constituent character, and calculating the respective widths of the two consonants, and further calculating the width of the analyzed constituent character, wherein the width of the analyzed constituent character is a summation of the respective widths of the two consonants;
adding the widths of each of the analyzed constituent characters and generating a cumulative width, said cumulative width being a resultant of addition of widths of each of the analyzed constituent characters;
to comparing the cumulative width with the width of the string, and determining whether the cumulative width is greater than the width of the string; and
determining the user interface program to be compatible with the Indian language script, only in the event that the cumulative width is greater than the width of the string.

In accordance with the embodiments herein, the step of declaring the user interface program as being compatible with the Indian language script, further includes the step of determining the user interface program to be non-compatible with the Indian language script, only in the event that the cumulative width of the constituent characters is lesser than one and a half times the width of the entire string.

The embodiments herein envisages a non-transitory computer readable storage medium, having computer readable instructions stored thereupon, the instructions when executed by a processor cause a computer enabled device to:
select at least one string incorporating an Indian language script, wherein the string is designated to be displayed on a user interface controlled by the user interface program;
parse the string and split the string into constituent characters thereof;
determine the width of the string;
analyze each of the constituent characters of the string and calculate the width of an analyzed constituent character in the event that the constituent character is determined to be a vowel;
analyze each of the constituent characters of the string and calculate the width of an analyzed constituent character in the event that the constituent character is determined to be a consonant;
analyze each of the constituent characters of the string and determine whether an analyzed constituent character includes a combination of a consonant and a vowel-sign;
split the analyzed constituent character into the consonant and a vowel equivalent to the vowel-sign, only in the event that the analyzed constituent character is a combination of a consonant and a vowel-sign, and calculate the respective widths of the consonant and the vowel, and further calculate the width of the analyzed constituent character, wherein the width of the analyzed constituent character is a summation of the respective widths of the consonant and the vowel;
analyze each of the constituent characters of the string and determine whether an analyzed constituent character is a conjunct consonant;
split the analyzed constituent character into at least two consonants, wherein said two consonants in combination would form the analyzed constituent character, and calculate the respective widths of the two consonants, and further calculate the width of the analyzed constituent character, wherein the width of the analyzed constituent character is a summation of the respective widths of the two consonants;
add the widths of each of the analyzed constituent characters and generate a cumulative width, said cumulative width being a resultant of addition of widths of each of the analyzed constituent characters;
compare the cumulative width with the width of the string, and determine whether the cumulative width is greater than the width of the string;
determine the user interface program to be compatible with the Indian language script, only in the event that the cumulative width is greater than the width of the string.

In accordance with the embodiments herein, the instructions, when executed by the processor, cause the computer enabled device to determine the user interface program to be non-compatible with the Indian language script, only in the event that the cumulative width of the constituent characters is lesser than one and a half times the width of the entire string.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will be apparent to those skilled in the art from the following description of the preferred embodiment and the accompanying drawings in which:

FIG. 1 is a system-level block diagram illustrating the components of the computer implemented system for determining the compatibility of a user interface program with an Indian language script; according to one embodiment herein.

FIG. 2 and FIG. 2A in combination provide a flow chart illustrating the steps involved in the method for determining the compatibility of a user interface program with an Indian language script, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

In order to overcome the drawbacks emphasized upon in the background section, the embodiments herein envisages a computer implemented system and method for determining the compatibility of a user interface program, with an Indian language script.

Typically, foreign languages such as English encompass a linear script, since the letters of an ‘English’ word include neither vowel-signs nor conjunct consonant characters. However, in case of Asian scripts including (but not restricted to) ‘Devanagari’, letters of a word are typically represented as a combination of vowels, consonants, vowel signs and conjunct consonant characters. Moreover, Devanagari representations may not follow a linear format all the time, contrary any Latin based script.

A typical user interface program which has been optimized to implement/display non-linear scripts/fonts may not be suitable for displaying script/fonts which are representing non-linear scripts such as the Devanagari. Since scripts such as the Devanagari, require rendering engines that function in a manner different than that of conventional rendering engines used to render linear scripts, a user interface program which uses a conventional rendering engine may not display non-linear scripts such as Devanagari in an appropriate manner.

Given that the (online/off-line) representation of non-linear scripts is completely different from representation of linear scripts, non-linear scripts are required to be processed by (a) user interface program in a manner different from processing of linear scripts. Further, the characteristics corresponding to the parameters analyzed by the user interface program including but not restricted to character recording, contextual shaping, recognition and display of vowel-signs, recognition and display of conjunct consonant characters, insertion of word breaks, processing sentence alignments, vary significantly, when a user interface program is required to display words/sentences based on non-linear scripts such as the Devanagari.

However, a user interface program which has been specifically designed and optimized to display linear scripts may not appropriately monitor and analyze the differences in the aforementioned parameters, during the display of a non-linear script, thereby resulting in the non-linear script being displayed in an inappropriate manner and in a manner which is not aesthetic, and not easily comprehendible by a user.

Therefore, in order to obviate the aforementioned drawbacks, the embodiments herein envisages a computer implemented system and method that determines whether a user interface program is compatible with Indian Language scripts including but not restricted to Devanagari.

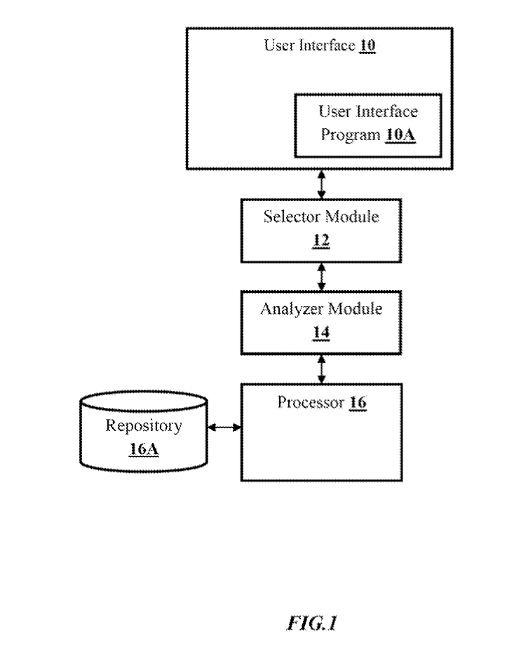

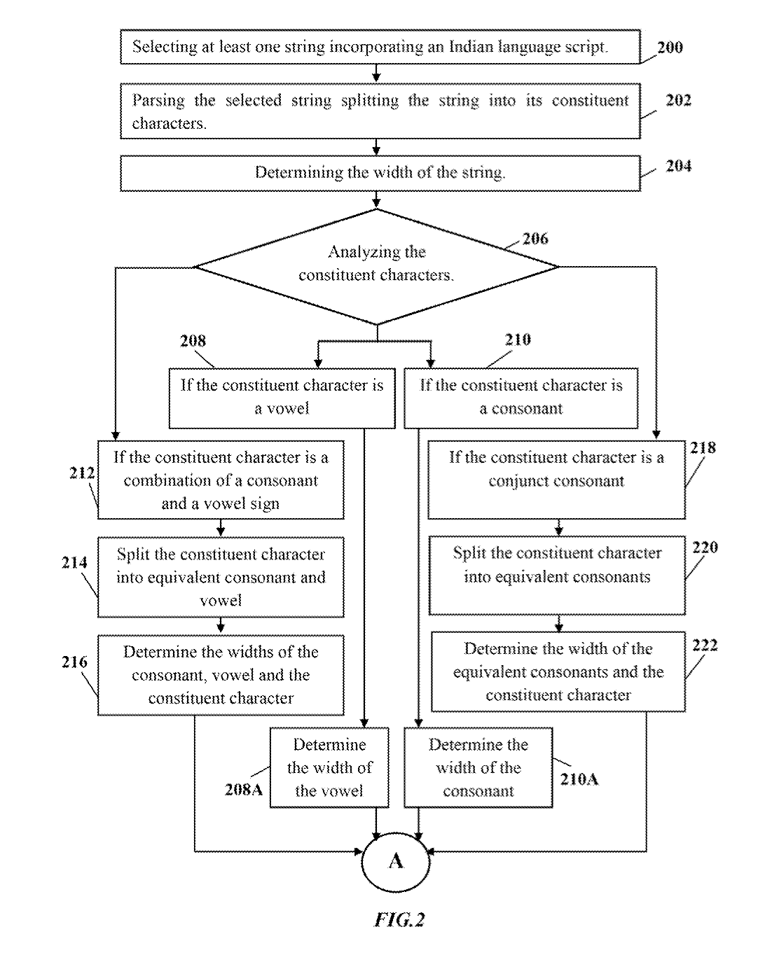

Referring to FIG. 1, there is shown a system 100 for determining whether a user interface program 10A (implemented on a user interface denoted by reference numeral 10) is compatible with Indian Language scripts including but not restricted to Hindi, Marathi, Kannada, Sanskrit, Konkani, Tamil, Telugu, Gujarati, Punjabi, Oriya, Malayalam and Manipuri, according to one embodiment herein. The system 100 determines whether a user interface program 10A is capable of rendering an Indian language script, and whether the user interface program 10A is capable of displaying the information represented in the said Indian language script, on the user interface 10.

In accordance with the embodiments herein, the system 100 includes a selector module 12. The selector module 12 accesses at least the textual portions of the information represented in an Indian language script. The information (represented in the said Indian language script) can be stored in a centralized repository (not shown in figures) accessible to a plurality of client computers via Internet. In accordance with the embodiments herein, the information represented in the said Indian Language is typically rendered onto and displayed upon the user interface 10 controlled by the user interface program 10A. The selector module 12 accesses the information represented in an Indian language script, when the information is displayed on the user interface 10, and selects at least one string therefrom for analyzing the compatibility of the user interface 10.

In accordance with the embodiments herein, the selector module 12 cooperates with an analyzer module 14 that parses the textual information (which is typically represented in the form of a string, and therefore referred to as ‘string’ hereafter) selected by the selector module 12 and subsequently splits the string into its consistent characters. It is also possible that a string contains only one alphabet. The term constituent character, in the context of the embodiments herein represents the characters that when combined form the string.

In accordance with the embodiments herein, the analyzer module 14 cooperates with a processor 16 that processes the string and the constituent characters thereof. The processor 16 subsequently determines the length of the (entire) string using a predetermined API (Application Program Interface), for example, API ‘getelementbyID’ defined in Java framework. The ‘getelementbyID’ is a well known Java API which is used inter-alia to determine the properties of a string, including the length of the string.

Subsequently, the processor 16 processes the constituent characters, preferably one at a time. In accordance with the embodiments herein, the processor 16 analyzes each of the constituent characters of the string, and determines whether an analyzed constituent character is a vowel or a consonant. The determination of a constituent character being a vowel or a consonant is performed based on pre-defined language rules, preferably stored in a repository 16A. The processor 16 calculates the width of the constitute character, in the event that the said constituent character is either a vowel or a consonant. The processor 16 subsequently determines the length of the said constituent character using the ‘getelementbyID’ API.

In the event that the said constituent character is determined as being neither a vowel nor a consonant, the processor 16 determines whether the constituent character is a combination of a consonant and vowel-sign. In the event that the constituent character is determined to include a combination of a consonant and a vowel-sign (a scenario which is applicable only in Indian language scripts, and not to Latin based language scripts which the conventional user interface programs are optimized to implement), the processor 16 splits the constituent character into the consonant and a vowel equivalent to the vowel-sign, and calculates the respective widths of the consonant and the vowel using the ‘getelementbyID’ API. Subsequently, the processor 16 calculates the width of the said constituent character, the width of the analyzed constituent character, in this case being a summation of the widths of the consonant and the vowel.

In the event that the said constituent character is determined as being neither a vowel nor a consonant or as a combination of a consonant and a vowel-sign, the processor 16 determines whether the constituent character is a conjunct consonant. In the event that the processor 16 determines the constituent character to be a conjunct consonant (that is, a combination of two consonants), the processor 16 splits the said constituent character into respective consonants (which in combination would have formed the constituent consonant), and calculates the widths of respective consonants. Subsequently, the processor 16 calculates the width of the said constituent character, the width of the analyzed constituent character being a summation of the widths of the respective consonants. Typically, a conjunct consonant is a combination of a consonant and a half consonant. The processor 16 splits the conjunct consonant into a corresponding consonant and a corresponding half-consonant, and determines a consonant that is equivalent to the half-consonant. The consonants are utilized by the processor 16 for calculating the width of the conjunct consonant.

The processor 16 repeats the aforementioned operation until the entire string has been traversed and the widths of each of the constituent characters of the string are determined. The processor 16 subsequently summates the widths of each of the constituent characters of the string, and calculates a consolidated width.

In accordance with the embodiments herein, the processor 16 compares the total width of the string with the consolidated width. The processor 16 determines the user interface program 10A to be supporting the Indian language script, only in the event the consolidated width (of the characters of the string) is greater than the total width (of the string). Preferably, the user interface program 10A is determined to be supporting the Indian language script, in the event the consolidated width is at least one and a half times greater than the total width. In the event that the consolidated width (of the characters of the string) is lesser than or equal to the total width (of the string), the processor 16 determines the user interface program 10A to be non-compatible with the Indian language script.

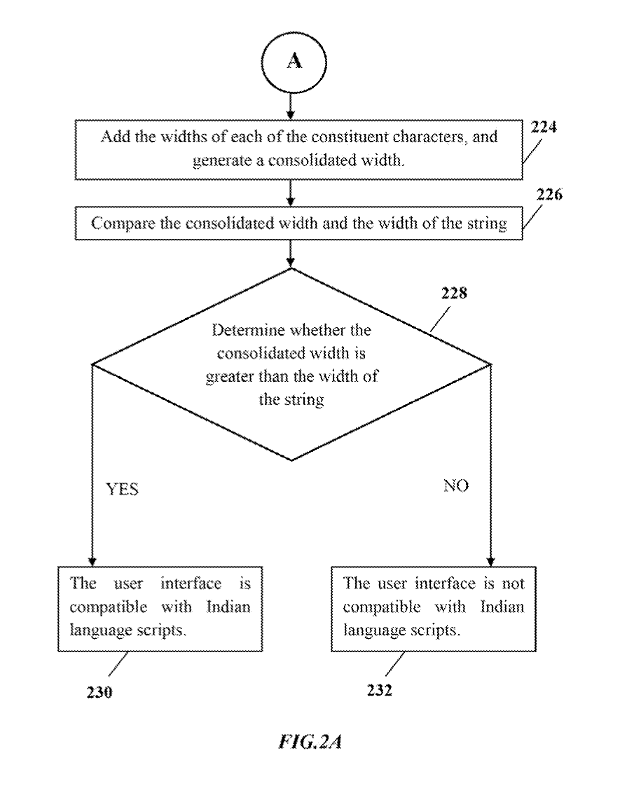

Referring to FIG. 2 and FIG. 2A in combination, there is shown a computer implemented method for determining the compatibility of a user interface program with an Indian language script, according to one embodiment herein. At step 200, at least one string incorporating an Indian language script is selected. The selected string is displayed on a user interface controlled by the user interface program. At step 202, the selected string is parsed by an analyzer module and the parsed string is subsequently split into its constituent characters. At step 204, the width of the string is determined by a processor.

At step 206, each of the constituent characters of the string are analyzed by the processor, and the width of the constituent character is calculated at step 208A only in the event that the constituent character is a vowel. Otherwise, at step 210, it is determined whether the constituent character is a consonant, and if the constituent character is indeed a consonant, the processor calculates the width of the constituent character at step 210A.

Step 212 of the method is invoked only in the event that the constituent character is determined to be neither a vowel nor a consonant. At step 212, the processor determines whether the constituent character includes a combination of a consonant and a vowel-sign. In the event that the constituent character includes a combination of a vowel-sign and a consonant, the processor at step 214, splits the constituent character into the consonant and a vowel equivalent to the vowel-sign, and at step 216 the processor calculates the respective widths of the consonant and the vowel, and subsequently the processor calculates the width of the analyzed constituent character. The width of the analyzed constituent character is a summation of the respective widths of the consonant and the vowel.

Step 218 of the method is invoked only in the event that the constituent character is determined not to be a vowel, not to be a consonant and not to be including a combination of a consonant and a vowel-sign. At step 218, the processor analyzes whether the constituent character is a conjunct consonant. If the constituent character is a conjunct consonant, then at step 220, the processor splits the conjunct consonant into at least two consonants, two consonants which in combination would have formed the analyzed constituent character. At step 222, the processor calculates the widths of the two consonants, and also calculates the width of the analyzed constituent character, the width of the analyzed constituent character being a summation of the respective widths of the two consonants.

At step 224, the widths of each of the constituent characters of the string are added and a cumulative width is generated. At step 226, the cumulative width is compared with the width of the string and the processor, at step 228 determines whether the cumulative width is greater than the width of the (entire) sting. At step 230, the processor determines the user interface program to be compatible with the Indian language script, only in the event that the cumulative width is greater than the width of the string.

In accordance with the embodiments herein, the step of declaring the user interface program as being compatible with the Indian language script, further includes the step of determining the user interface program to be non-compatible with the Indian language script, only in the event that the cumulative width of the constituent characters is lesser than one and a half times the width of the entire string.

The embodiments herein also envisages a non-transitory computer readable storage medium, having computer readable instructions stored thereupon, the instructions when executed by a processor cause a computer enabled device to:
select at least one string incorporating an Indian language script, wherein the string is displayed on a user interface controlled by the user interface program;
parse the string and split the string into constituent characters thereof;
determine the width of the string;
analyze each of the constituent characters of the string and calculate the width of an analyzed constituent character in the event that the constituent character is determined to be a vowel;
analyze each of the constituent characters of the string and calculate the width of an analyzed constituent character in the event that the constituent character is determined to be a consonant;
analyze each of the constituent characters of the string and determine whether an analyzed constituent character includes a combination of a consonant and a vowel-sign;
split the analyzed constituent character into the consonant and a vowel equivalent to the vowel-sign, only in the event that the analyzed constituent character is a combination of a consonant and a vowel-sign, and calculate the respective widths of the consonant and the vowel, and further calculate the width of the analyzed constituent character, wherein the width of the analyzed constituent character is a summation of the respective widths of the consonant and the vowel;
analyze each of the constituent characters of the string and determine whether an analyzed constituent character is a conjunct consonant;
split the analyzed constituent character into at least two consonants, wherein said two consonants in combination would form the analyzed constituent character, and calculate the respective widths of the two consonants, and further calculate the width of the analyzed constituent character, wherein the width of the analyzed constituent character is a summation of the respective widths of the two consonants;
add the widths of each of the analyzed constituent characters and generate a cumulative width, said cumulative width being a resultant of addition of widths of each of the analyzed constituent characters;
compare the cumulative width with the width of the string, and determine whether the cumulative width is greater than the width of the string; and
determine the user interface program to be compatible with the Indian language script, only in the event that the cumulative width is greater than the width of the string.

In accordance with the embodiments herein, the instructions stored on the non-transitory computer readable medium, when executed by the processor, cause the computer enabled device to determine the user interface program to be non-compatible with the Indian language script, only in the event that the cumulative width of the constituent characters is lesser than one and a half times the width of the entire string.

The technical advantages envisaged by the embodiments herein include the realization of a computer implemented system that determines the compatibility of a user interface program with respect to a script, preferably a non-linear script. The system envisaged by the embodiments herein determines whether a user interface program is capable of supporting an Indian script such as (but not restricted to) Devanagari, which includes letters being typically expressed as a combination of vowels, consonants, vowel-signs and half consonants unlike Latin scripts which typically make use of only a combination of vowels and consonants. The system envisaged by the embodiments herein ascertains the characteristics of the script to be rendered on the user interface, to determine whether the said script is supported by the user interface. The script related characteristics ascertained by the system include text size, text style, text font, the alphabets used in the text, and the like. Further, the system envisaged by the embodiments herein enables a user to determine whether an Indian language script such as Devanagari is supported by a user interface (program). The computer implemented system envisaged by the embodiments herein is an easy-to-use computer implemented system which enables the user to determine the compatibility of a user interface with respect to Indian language scripts, without taking into consideration the programming specifics of the user interface.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

We claim:

1. A computer implemented system for determining the compatibility of a user interface program with an Indian language script, said system comprising:
a selector module configured to select at least one string, said string comprising at least two characters represented in the Indian language script, said string displayed on a user interface controlled by the user interface program;
a parser module configured to parse the string and split the string into constituent characters thereof;
a processor cooperating with said parser module, said processor configured to:
determine the width of the string;
analyze each of the constituent characters of the string and calculate the width of an analyzed constituent character in the event that the constituent character is determined to be a vowel;
analyze each of the constituent characters of the string and calculate the width of an analyzed constituent character in the event that the constituent character is determined to be a consonant;
analyze each of the constituent characters of the string and determine whether an analyzed constituent character includes a combination of a consonant and a vowel-sign;
split the analyzed constituent character into the consonant and a vowel equivalent to the vowel-sign, only in the event that the analyzed constituent character is a combination of a consonant and a vowel-sign, and calculate the widths of the consonant and the vowel, and further calculate the width of the analyzed constituent character, wherein the width of the analyzed constituent character is a summation of the widths of the consonant and the vowel;
analyze each of the constituent characters of the string and determine whether an analyzed constituent character is a conjunct consonant;
split the analyzed constituent character into at least two consonants, in the event that the analyzed constituent character is a conjunct character, said two consonants in combination forming the analyzed constituent character, and calculate the widths of the two consonants, and further calculate the width of the analyzed constituent character, wherein the width of the analyzed constituent character is a summation of the widths of the two consonants;
add the widths of each of the analyzed constituent characters and generate a cumulative width, said cumulative width being a resultant of addition of widths of each of the analyzed constituent characters;
compare the cumulative width with the width of the string, and determine whether the cumulative width is greater than the width of the string; and
determine the user interface program to be compatible with the Indian language script, only in the event that the cumulative width is greater than the width of the string.

2. The system as claimed in claim 1, wherein said processor is further configured to determine the user interface program to be compatible with the Indian language script, only in the event that the cumulative width is at least one and a half times greater than the width of the string.

3. The system as claimed in claim 1, wherein said processor is further configured to declare the user interface program as being non-compatible with the Indian language script, only in the event that the cumulative width of the constituent characters is lesser than one and a half times the width of the entire string.

4. A computer implemented method for determining the compatibility of a user interface program with an Indian language script, said method comprising the following computer implemented steps:
selecting at least one string incorporating an Indian language script, wherein the string is displayed on a user interface controlled by the user interface program;
parsing the string and splitting the string into constituent characters thereof;
determining the width of the string;
analyzing each of the constituent characters of the string and calculating the width of an analyzed constituent character in the event that the constituent character is determined to be a vowel;
analyzing each of the constituent characters of the string and calculating the width of an analyzed constituent character in the event that the constituent character is determined to be a consonant;
analyzing each of the constituent characters of the string and determining whether an analyzed constituent character includes a combination of a consonant and a vowel-sign;
splitting the analyzed constituent character into the consonant and a vowel equivalent to the vowel-sign, only in the event that the analyzed constituent character is a combination of a consonant and a vowel-sign, and calculating the widths of the consonant and the vowel, and further calculating the width of the analyzed constituent character, wherein the width of the analyzed constituent character is a summation of the widths of the consonant and the vowel;
analyzing each of the constituent characters of the string and determining whether an analyzed constituent character is a conjunct consonant;
splitting the analyzed constituent character into at least two consonants, only in the event that the analyzed constituent character is a conjunct consonant, said two consonants in combination forming the analyzed constituent character, and calculating the respective widths of the two consonants, and further calculating the width of the analyzed constituent character, wherein the width of the analyzed constituent character is a summation of the respective widths of the two consonants;
adding the widths of each of the analyzed constituent characters and generating a cumulative width, said cumulative width being a resultant of addition of widths of each of the analyzed constituent characters;
comparing the cumulative width with the width of the string, and determining whether the cumulative width is greater than the width of the string; and
determining the user interface program to be compatible with the Indian language script, only in the event that the cumulative width is greater than the width of the string.

5. The method as claimed in claim 4, wherein the step of declaring the user interface program as being compatible with the Indian language script, further includes the step of determining the user interface program to be non-compatible with the Indian language script, only in the event that the cumulative width of the constituent characters is lesser than one and a half times the width of the string.

6. A non-transitory computer readable storage medium, having computer readable instructions stored thereupon, the instructions when executed by a processor cause a computer enabled device to:
select at least one string incorporating an Indian language script, wherein the string is displayed on a user interface controlled by the user interface program;
parse the string and split the string into constituent characters thereof; determine the width of the string;
analyze each of the constituent characters of the string and calculate the width of an analyzed constituent character in the event that the constituent character is determined to be a vowel;
analyze each of the constituent characters of the string and calculate the width of an analyzed constituent character in the event that the constituent character is determined to be a consonant;
analyze each of the constituent characters of the string and determine whether an analyzed constituent character includes a combination of a consonant and a vowel-sign;
split the analyzed constituent character into the consonant and a vowel equivalent to the vowel-sign, only in the event that the analyzed constituent character is a combination of a consonant and a vowel-sign, and calculate the respective widths of the consonant and the vowel, and further calculate the width of the analyzed constituent character, wherein the width of the analyzed constituent character is a summation of the widths of the consonant and the vowel;
analyze each of the constituent characters of the string and determine whether an analyzed constituent character is a conjunct consonant;
split the analyzed constituent character into at least two consonants, only in the event that the analyzed constituent character is a conjunct consonant, said two consonants in combination forming the analyzed constituent character, and calculate the respective widths of the two consonants, and further calculate the width of the analyzed constituent character, wherein the width of the analyzed constituent character is a summation of the widths of the two consonants;
add the widths of each of the analyzed constituent characters and generate a cumulative width, said cumulative width being a resultant of addition of widths of each of the analyzed constituent characters;
compare the cumulative width with the width of the string, and determine whether the cumulative width is greater than the width of the string;
determine the user interface program to be compatible with the Indian language script, only in the event that the cumulative width is greater than the width of the string.

7. The non-transitory computer readable storage medium as claimed in claim 6 wherein the instructions, when executed by the processor, cause the computer enabled device to determine the user interface program to be non-compatible with the Indian language script, only in the event that the cumulative width of the constituent characters is lesser than one and a half times the width of the string.
